(19) United States
(12) Patent Application Publication
(10) Pub. No.: US 2008/0218624 A1
(43) Pub. Date: Sep. 11, 2008

(54) IMAGE PICKUP APPARATUS

(76) Inventors: Satoko Furuki, Utsunomiya-shi (JP); Nobuyuki Watanabe, Yokohama-shi (JP)

Correspondence Address: STRAUB & POKOTYLO, 788 Shrewsbury Avenue, TINTON FALLS, NJ, 07724, US

(21) Appl. No.: 12/036,892

(22) Filed: Feb. 25, 2008

Related U.S. Application Data
(63) Continuation of application No. PCT/JP2006/316751, filed on Aug. 25, 2006.

(30) Foreign Application Priority Data
Aug. 26, 2005 (JP) 2005-246095

(51) Int. Cl. H04N 5/232

(52) U.S. Cl. 348/345; 348/349; 348/E05.042

(57) ABSTRACT

An image pickup apparatus includes an optical system which forms an image based on light from object, an image pickup device which acquires the image of the object, a display section which displays the object, and a focusing detection inoperative condition and a focusing detection operative condition. The image pickup apparatus further includes an image pickup instructing section (release button) which instructs an image of the object to be picked up, and a control section which performs control such that when the image pickup instructing section (release button) is in the focusing detection operative condition, an image in the focusing detection inoperative condition is displayed on the display section.

### CROSS REFERENCE TO RELATED APPLICATIONS

This is a Continuation Application of PCT Application No. PCT/JP2006/316751, filed Aug. 25, 2006, which was published under PCT Article 21(2) in Japanese.

This application is based upon and claims the benefit of priority from prior Japanese Patent Application No. 2005-246095, filed Aug. 26, 2005, the entire contents of which are incorporated herein by reference.

### BACKGROUND OF THE INVENTION

1. Field of the Invention

The present invention relates to an image pickup apparatus having a focusing detecting section that performs focusing detection.

2. Description of the Related Art

For example, U.S. Pat. No. 4,965,840 describes a method of arithmetically processing a plurality of images with different blur levels to calculate a spread parameter and acquiring luminance information at two positions with different optical path lengths for focusing determination. Here, the spread parameter refers to a representative value for a blur level indicated in the luminance information, which value correlates with the variance of a point spread function (PSF) of an optical system. Here, PSF refers to a function representative of the spread of light beams obtained when an ideal point image passes through an optical system.

FIG. 11 shows steps of a focusing determining method described in U.S. Pat. No. 4,965,840. The focusing determining system acquires at least two pieces of focusing-determining luminance information for the same subject, the same site of the subject, and the same direction of view by varying at least one camera parameter that has an effect on the blur condition of a picked-up image. The camera parameter may be a focus lens position, an aperture amount, a focal distance, or the like. In the description of the present invention, only the focal lens position is varied, as shown in FIG. 13.

FIGS. 12(a) and 12(b) show that a focused focal point is acquired by driving a focus lens to vary the position of the lens and thus a blur condition. FIG. 13 shows an example configuration of a camera system in this case.

According to the focusing determining method, first, a first camera parameter set and a second camera parameter set are defined (steps S101-1 and S101-2). The focus lens is then moved to a predetermined first position (FIG. 12(a)) and to a predetermined second position (FIG. 12(b)) in order to vary the optical path length from focal surfaces FM1 and FM2 to an object D. Thus, a first piece of luminance information and a second piece of luminance information are acquired (steps S102-1 and S102-2).

The luminance information acquired is then subjected to normalization processes such as image scaling and luminance distribution (steps S103-1 and S103-2). An area to be subjected to focusing determination is selected from the luminance information acquired as required. The selection is performed on one of the two pieces of information (in this case, the first piece of image information) (step S104-1). A focusing determination area for a second image acquired is selected for the other piece of image information (second piece of image information); the focusing determination area corresponds to the focusing determination image processing area in the first acquired image (step S104-2).

The first and second pieces of luminance information may contain information on electric noise from a luminance information acquiring section. Thus, as a preprocess for the calculation of a blur amount, an arithmetic operation for removing noise, an arithmetic operation for calculating the variance of PSF, and the like are performed on the focusing determination areas selected from the first and second piece of luminance information (steps S105-1 and S105-2). The results of the two arithmetic operations are united together to calculate the variance of PSF corresponding to the first or second piece of luminance information according to this technique (step S106). A subject distance is determined from the calculated variance of PSF on the basis of a relation between the variance of PSF and the subject distance described in U.S. Pat. No. 4,965,840 (step S107).

Furthermore, U.S. Pat. No. 5,193,124 pre-acquires a table showing the correspondence between a spread parameter that correlates with the variance of PSF in an area on an image surface 2 in FIGS. 12(a) and 12(b) and a command value sent to a focus lens driving section in order to set the focus lens portion for focusing. The spread parameter is a value representative of the ratio of MTF described in U.S. Pat. No. 5,193,124 or a difference in the variance of PSF between two images with different blur levels described in U.S. Pat. No. 5,148,209. Thus, the spread parameter for a focusing detection area is calculated, and with reference to the above-described table, a movement command value for a driving actuator is generated, which sets the focus lens position for focusing.

### BRIEF SUMMARY OF THE INVENTION

According to a first aspect of the present invention, there is provided an image pickup apparatus having a focusing detection operative condition and a focusing detection inoperative condition, the apparatus comprising:

an optical system which forms an image based on light from object;

an image pickup device which obtains the image of the object;

a display section which displays the image of the object;

a focusing detecting section; and

an image pickup instructing section which permits the focusing detecting section to go into the focusing detection operative condition and which instructs an image of the object to be picked up,

wherein the display section displays the image of the object taken with the optical system in a predetermined arrangement when the image pickup instructing section permits the focusing detection operative condition.

According to a second aspect of the present invention, there is provided an image pickup apparatus according to the first aspect, wherein the image of the object taken with the optical system in the predetermined arrangement is taken with the arrangement of the optical system made before the focusing detection operative condition.

According to a third aspect of the present invention, there is provided an image pickup apparatus according to the first aspect, wherein the image of the object taken with the optical system in the predetermined arrangement is taken with a first predetermined arrangement of the optical system acquired in one focusing detection operative condition.

According to a fourth aspect of the present invention, there is provided an image pickup apparatus according to the second aspect, wherein the display device further displays the image taken with the arrangement of the optical system established for the one focusing detection operative condition.

According to a fifth aspect of the present invention, there is provided an image pickup apparatus according to the third aspect, wherein the display device further displays the image taken with the arrangement of the optical system established for the one focusing detection operative condition.

According to a sixth aspect of the present invention, there is provided an image pickup apparatus according to the fourth aspect, wherein the image pickup instructing section permits a plurality of focusing detection operative conditions, and

the display section displays the image taken with the arrangement of the optical system established for the one focusing detection operative condition, in a next focusing detection operative condition.

According to a seventh aspect of the present invention, there is provided an image pickup apparatus according to the fifth aspect, wherein the image pickup instructing section permits a plurality of focusing detection operative conditions, and

the display section displays the image taken with the arrangement of the optical system established for the one focusing detection operative condition, in a next focusing detection operative condition.

According to an eighth aspect of the present invention, there is provided an image pickup apparatus according to the first aspect, wherein the image pickup device has a function of performing a plurality of reading operations, and further has an image pickup device control section which controls the reading operation of the image pickup device, and

in the focusing detection operative condition, pieces of luminance information on a plurality of pixels in a vicinity of the pixels on the image pickup device are additively mixed together and then read.

According to a ninth aspect of the present invention, there is provided an image pickup apparatus according to the first aspect, wherein the image pickup device has a function of performing a plurality of reading operations, and further has an image pickup device control section which controls the reading operation of the image pickup device, and

in the focusing detection operative condition, luminance information on a partial area on the image pickup device which is made up of at least one pixel is read.

According to a tenth aspect of the present invention, there is provided an image pickup apparatus according to the first aspect, wherein a focusing information acquiring section which acquires the focusing information comprises:

an image acquiring section which uses the image pickup device to acquire a plurality of images with different blur levels formed by light having passed through the optical system;

a luminance information acquiring section which acquires luminance information on corresponding areas in at least two of the plurality of images;

a spread parameter calculating section which calculates a spread parameter from the luminance information on the corresponding areas; and

a control section which relates the spread parameter to a command value sent to a drive section which drives the optical system to a position at which an image focusing on the object is obtained.

According to an eleventh aspect of the present invention, there is provided an image pickup apparatus according to the first aspect, further comprising:

a recording section in which image information to be displayed on the display section is recorded;

a counter which measures the time for which the image information recorded in the recording section is held; and

an updating section which updates the image information recorded in the recording section.

### BRIEF DESCRIPTION OF THE SEVERAL VIEWS OF THE DRAWING

FIG. 1 is a diagram showing the configuration of an image pickup apparatus in accordance with a first embodiment of the present invention;

FIG. 2 is a timing chart (1) illustrating the effects of the first embodiment;

FIG. 3 is a timing chart (2) illustrating the effects of the first embodiment;

FIG. 4 is a flowchart illustrating the effects of the first embodiment;

FIG. 5 is a diagram showing the configuration of an image pickup apparatus in accordance with a second embodiment of the present invention;

FIG. 6 is a diagram showing an image mixed reading operation of adding two horizontal images together;

FIG. 7 is a diagram showing an image mixed reading operation of adding two vertical images and two horizontal images together;

FIG. 8 is a diagram showing an area 101 in the vicinity of a center of an image pickup device 2 in which sampling is performed;

FIG. 9 is a diagram showing nine areas for sampling;

FIG. 10 is a timing chart illustrating the effects of the first embodiment;

FIG. 11 is a diagram showing steps of a focusing determining method described in the Background Art section;

FIG. 12 is a diagram showing that a focused focal point is acquired by driving a focus lens to vary the position of the focus lens and thus a blur condition; and

FIG. 13 is a diagram showing an example of the configuration of a camera system for acquiring the focused focal point.

### DETAILED DESCRIPTION OF THE INVENTION

### First Embodiment

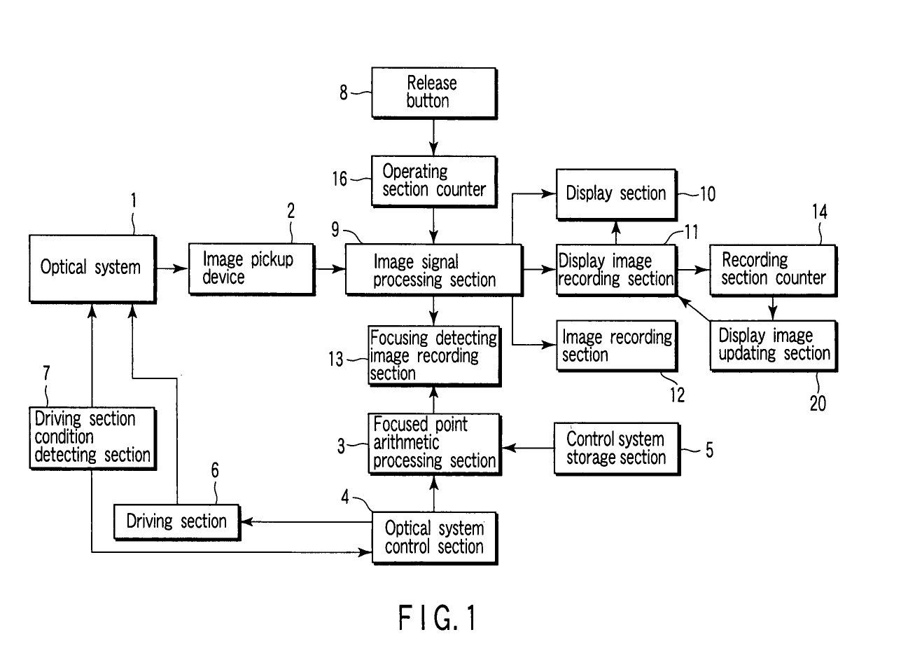

A first embodiment of the present invention will be described below with reference to the drawings. FIG. 1 is a diagram showing the configuration of an image pickup apparatus in accordance with the first embodiment. The image pickup apparatus is made up of an optical system 1, an image pickup device 2, a focused focal point arithmetic processing section 3, an optical system control section 4, a control system storage section 5, a driving section 6, a driving section condition detecting section 7, a release button (image pickup instructing section) 8, an image signal processing section (control section) 9, a display section 10, a display image recording section 11, an image recording section 12, a focusing detecting image recording section 13, a recording section counter 14, and an operating section counter 16.

With the above configuration, when the optical system 1 forms an image of a subject on an image pickup device 2, the image pickup device 2 converts the image into an electric signal. The electric signal is processed differently depending on whether the purpose is 1. to display the image or 2. to acquire focusing information or 3. to record the image. For example, in the case of 1., the electric signal is processed by the image signal processing section 9, and the processed signal is then sent to the display section 10. In the case of 2., the electric signal is sent to the focused focal point arithmetic processing section 3. In the case of 3., the electric signal is processed by the image signal processing section 9 and sent to the image recording section 12. The release button 8 is used by the user to switch among 1. and 2. and 3.

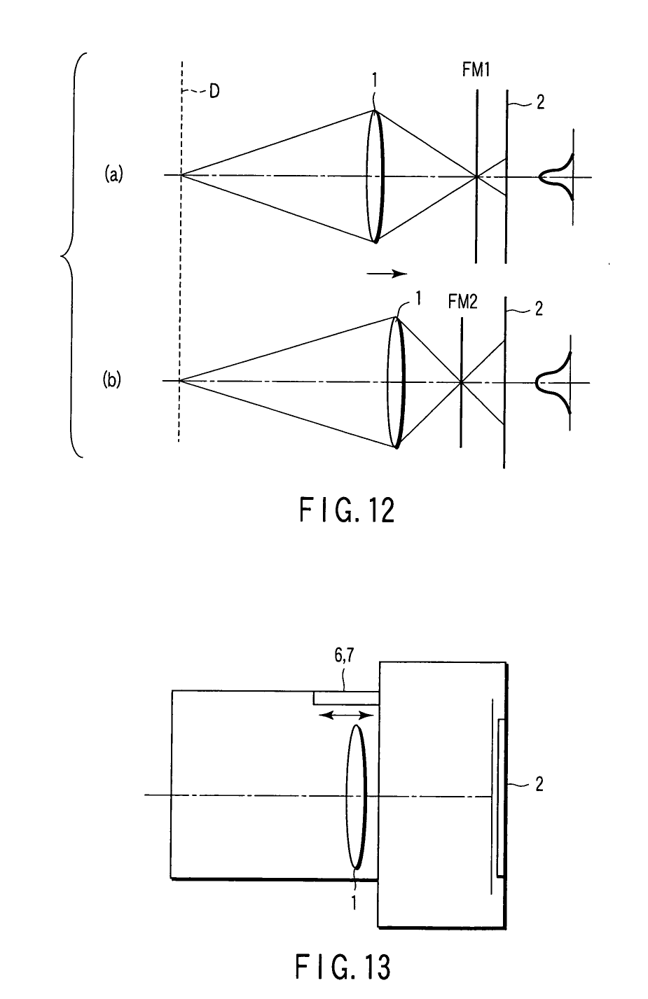

Now, with reference to FIGS. 12(a) and 12(b), description will be given of a method for acquiring focusing information, which method is used in the present embodiment. The driving section 6 is composed of an actuator such as a motor, a signal generating circuit that generates signals for driving the actuator, and a mirror frame that combines the optical system 1 with the actuator. The motor acts on the mirror frame, combining a focus lens, the optical system 1, with the motor, to drive the optical system 1 to control the position of the optical system 1. The optical path length between an object D and focal surfaces (FM1 and FM2) is adjusted to control the possible blur of an image on the image pickup device 2. The position of the optical system 1 is controlled by measuring the position of the mirror frame using a signal from the driving section condition detecting section 7.

Then, the driving section 6 is used to control the optical system 1 to a predetermined first position (FIG. 12(a)) and to a predetermined second position (FIG. 12(b)), where the first and second image pickup devices 2, respectively, are used to take images. The taken images are converted, by the image signal processing section 9, into digital signals, which are then recorded in the focusing detecting image recording section 13. The focused focal point arithmetic processing section 3 uses the two pieces of luminance information with different blur levels recorded in the focusing detecting image recording section 13 to calculate a value (spread parameter) correlating with the variance of PSF. The calculating method may be the one shown in the Background Art section or any other technique.

Now, a table stored in the control system storage section 5 will be described. The control system storage section 5 stores spread parameters and command values to be sent to the driving section 6 in order to set focus lens positions required to obtain focused images corresponding to the spread parameters; the spread parameters and the command values are in discrete value form.

The command value to be sent to the driving section 6 in order to set a focus lens position required to obtain a focused image is retrieved from the table stored in the control system storage section 5, on the basis of the spread parameter calculated from the two blurred images. The optical system control section 4 inputs the command value to the driving section 6. The optical system 1 is moved to a position appropriate for focusing to enable a focused condition to be achieved.

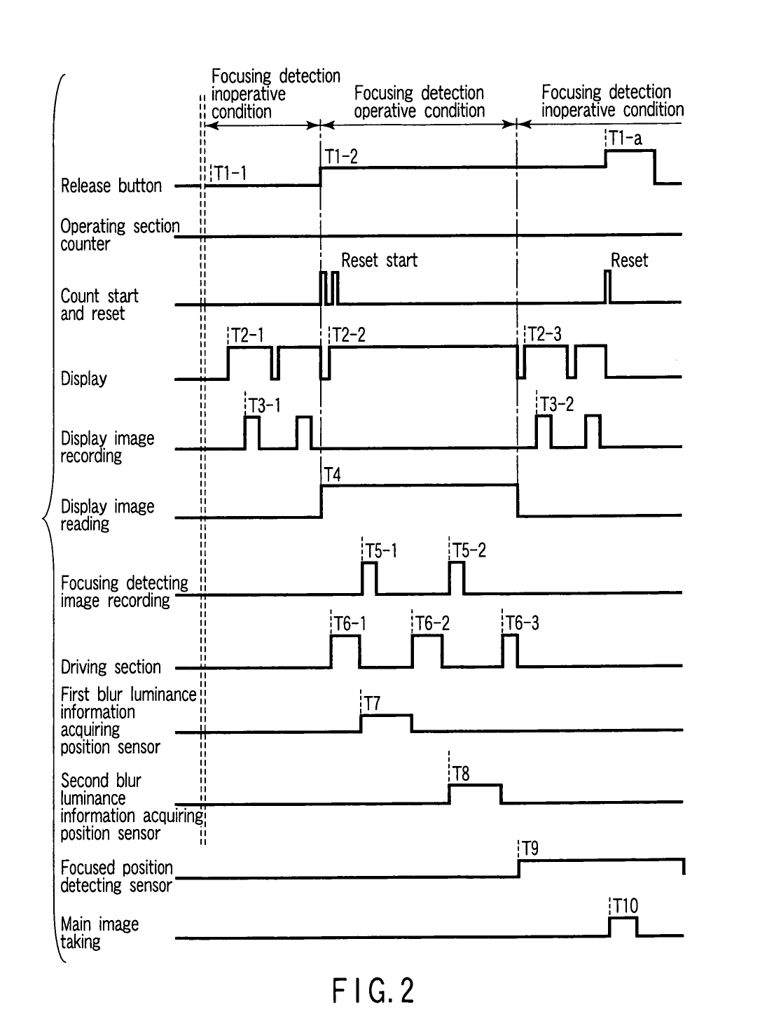

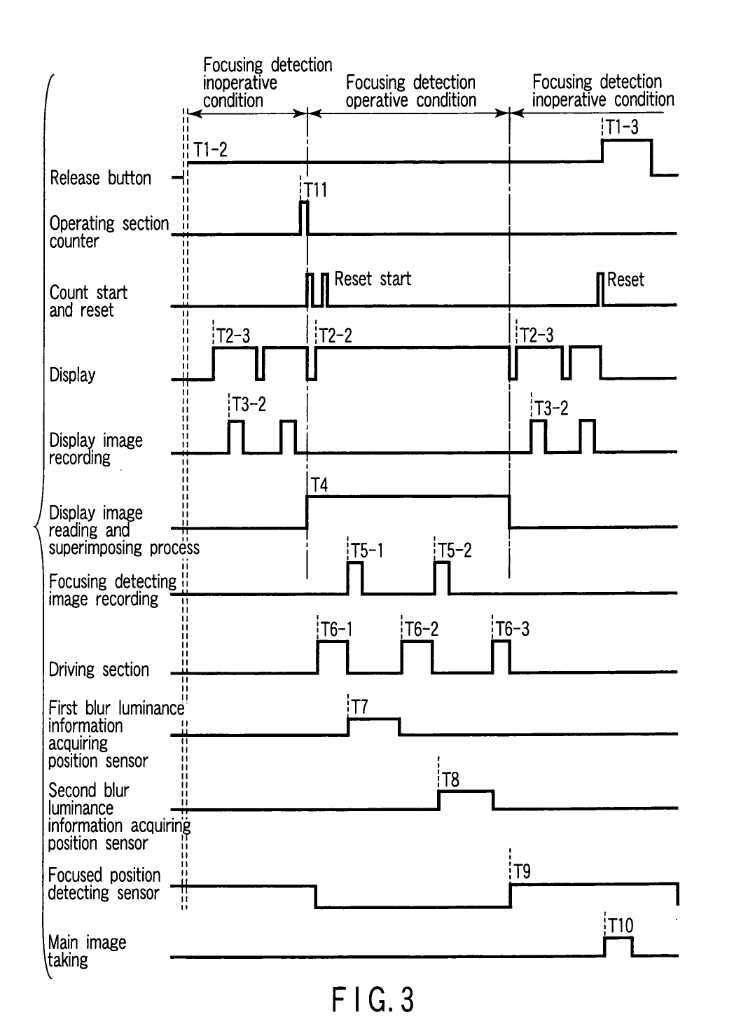

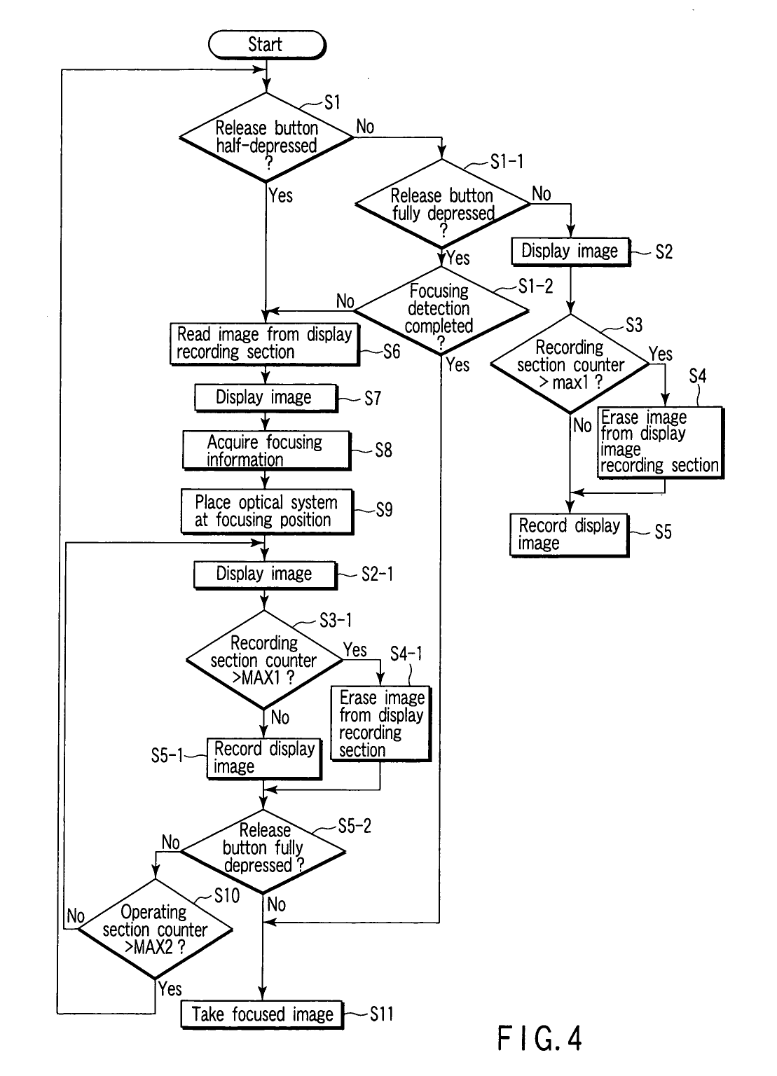

The effects of the present embodiment will be described with reference to FIGS. 2 to 4. FIG. 2 is a timing chart (1) illustrating the effects of the first embodiment. FIG. 3 is a timing chart (2) illustrating the effects of the first embodiment. FIG. 2 shows that the non-depressed released button 8 is half-depressed to shift to a focusing detection operative condition. FIG. 3 shows that the device is shifted to the focusing detection operative condition with the release button 8 remaining half-depressed. FIG. 4 is a flowchart illustrating the effects of the first embodiment.

First, the device determines whether or not the non-depressed release button 8 (T1-1 in FIG. 2: focusing detection inoperative condition) has been half-depressed (step S1 in FIG. 4). When the determination is YES, the process shifts to step S6. When the determination is NO, the device determines whether or not the release button 8 has been fully depressed (step S1-1 in FIG. 4). When the determination is YES, the process proceeds to step S1-2. When the determination is NO, an image picked up by the image pickup device 2 is displayed on the display section 10 (T2-1 in FIG. 2, step S2 in FIG. 4). The display image recording section 11 is a frame buffer for the display section 10. Images displayed on the display section 10 are sequentially recorded in the display image recording section 11 (T3-1 in FIG. 2). The recording section counter 16 manages the time for which frame buffer images have been held so that the display image recording section 11 can always hold the latest information. That is, if a comparison of the value in the recording section counter 16 with a maximum value MAX1 indicates that the value in the recording section counter 16 is greater than the maximum value MAX1, the image in the display image recording section 11 is erased to allow the latest display image to be recorded (steps S3, S4, and S5 in FIG. 4).

When the release button 8 is half-depressed and the determination in step S1 is YES, focusing detection is started (T1-2 in FIG. 2: focusing detection operative condition). The image recorded in the display image recording section 11 in T3-1 in FIG. 2 is read (T4 in FIG. 2, step S6) and displayed on the display section 10 (T2-2 in FIG. 2, step S7 in FIG. 4). While focusing information is being acquired, the read image is always displayed.

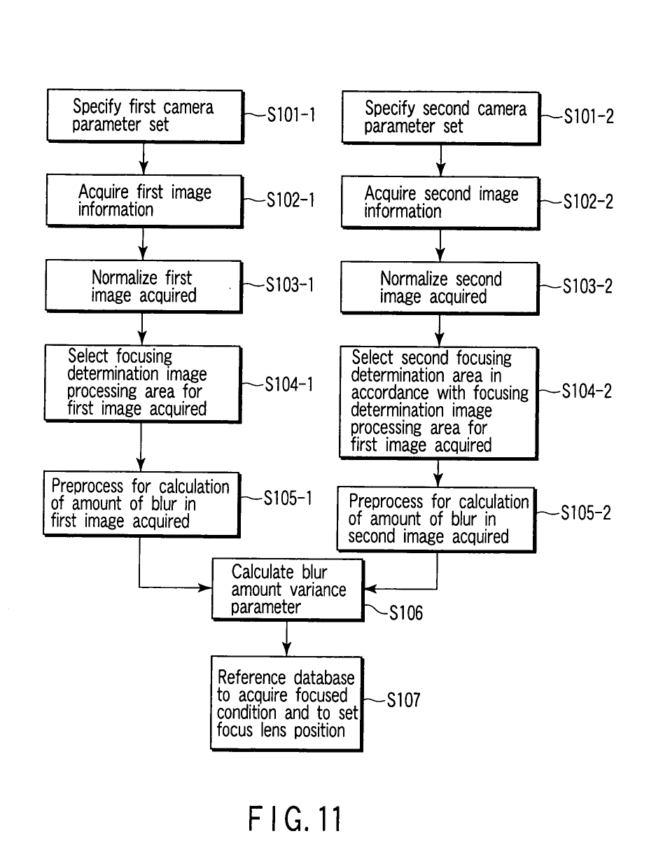

Then, the configuration in FIGS. 12(a) and 12(b) are used to acquire focusing information in accordance with a procedure shown in FIG. 11. That is, the driving section 6 places the optical system 1 at a first position where a first blurred image is to be obtained (T6-1 in FIG. 2). Luminance information is then acquired and the image is recorded for focusing detection (T5-1 in FIG. 2). The driving section 6 places the optical system 1 at a second position where a second blurred image is to be obtained (T6-2 in FIG. 2). Luminance information is then acquired (T5-2 in FIG. 2). Then, these pieces of luminance information are used to calculate a focused focal position in accordance with the procedure in FIG. 11 (step S8 in FIG. 4). The driving section 6 places the optical system 1 at a calculated focused focal position (T6-3 in FIG. 2, step S9 in FIG. 4). Once the optical system 1 is placed at the focused focal position, the focusing detection is completed.

When the focusing detection is completed, a picked-up image is displayed on the display section 10 as in the case of step S2 (T2-1 in FIG. 2, step S2-1 in FIG. 4) and held in the display image recording section 11 (T3-2 in FIG. 2, step S5-1 in FIG. 4). In this case, the recording section counter 14 manages the time for which frame buffer images have been held. The display image updating section 20 constantly updates the information held in the display image recording section 11. That is, if a comparison of the value in the recording section counter 14 with the maximum value MAX1 indicates that the value in the recording section counter 14 is greater than the maximum value MAX1, the image in the display image recording section 11 is erased to allow the latest display image to be constantly recorded (steps S3-1, S4-1, and S5-1).

The operating section counter 16 is connected to the release button 8 and measures the time elapsed since the last start of focusing detection. When a specified time elapses and the count value exceeds a maximum value MAX2 (T11 in FIG. 3, step S10 in FIG. 4), focusing detection is started again.

That is, the image recorded in the display image recording section 11 and taken in the focused condition is read (T4 in FIG. 3, step S6 in FIG. 4) and displayed (T2-2 in FIG. 3, step S7 in FIG. 4). During the display, a plurality of blurred images are taken to acquire focusing information (step S8 in FIG. 4). In this case, the image taking operation for acquiring focusing information may start at the lens position in the focused condition or at a different position.

Then, when the release button 8 is fully depressed and the determination in step S1-2 is YES, a focused image is taken (T10 in FIGS. 2 and 3: focusing detection inoperative condition, step S11 in FIG. 4) and the taken image is recorded in the image recording section 12. The above-described flow enables focusing detection to be achieved without the need to present the user with blurred images acquired during the acquisition of focusing information.

In the description of the present embodiment, after the focusing detection is completed, the release button 8 remains half-depressed for a while before the main image taking operation is started. However, the non-depressed release button 8 may be fully depressed without being half-depressed, to start the main image taking operation. Even when the released release button 8 is fully depressed without being half-depressed, if the focusing detection has not been completed, the focusing detection is completed before the main image taking operation is started. During the focusing detection, images are read from the display image recording section 11 and displayed as described above.

In the description of the present embodiment, the focus lens 1 is driven to obtain plural pieces of blur luminance information. However, the aperture diameter may be varied to acquire luminance information at different blur levels or a lens composed of a fluid may have its refractive index varied to obtain luminance information for different optical path lengths so as to allow the spread parameter to be calculated. Furthermore, at least one of the lens position, the aperture diameter, and the lens refractive index has only to be varied or the lens position, the aperture diameter, and the lens refractive index may all be simultaneously varied.

The optical system 1 is composed of a plurality of lens groups, for example, zoom lenses, focus lenses, diaphragms, and optical filters. The focused focal point arithmetic processing section 3 is a microprocessor that executes arithmetic processes. A plurality of focused focal point arithmetic processing sections 3 may be provided and may be implemented using ASICs or FPGAs. The optical system control section 4 comprises a driving circuit for the driving section 6 and an arithmetic processing section that executes arithmetic processes for control. The driving section 6 is composed of an electromagnetic motor, a piezoelectric element, an ultrasonic driving motor, or the like. The driving section condition detecting section 7 is a sensor that detects the speed, angular speed, position, temperature, pressure, light quantity, or the like of the driving section 6. The driving section condition detecting section 7 is composed of a gyro sensor, an encoder, an accelerometer, a thermometer, a pressure gauge, a light receiving element that measures the quantity of light, or the like.

The focused focal point arithmetic processing section executes the method based on the arithmetic operation of the spread parameter as described above. However, the focused focal point arithmetic processing section may execute a method of detecting contrast.

### Second Embodiment

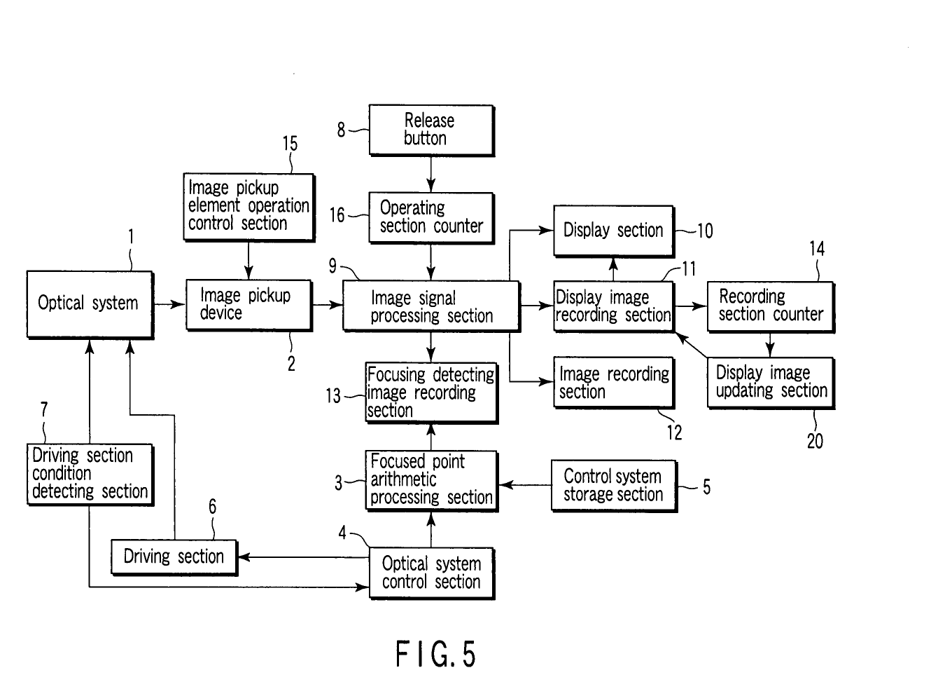

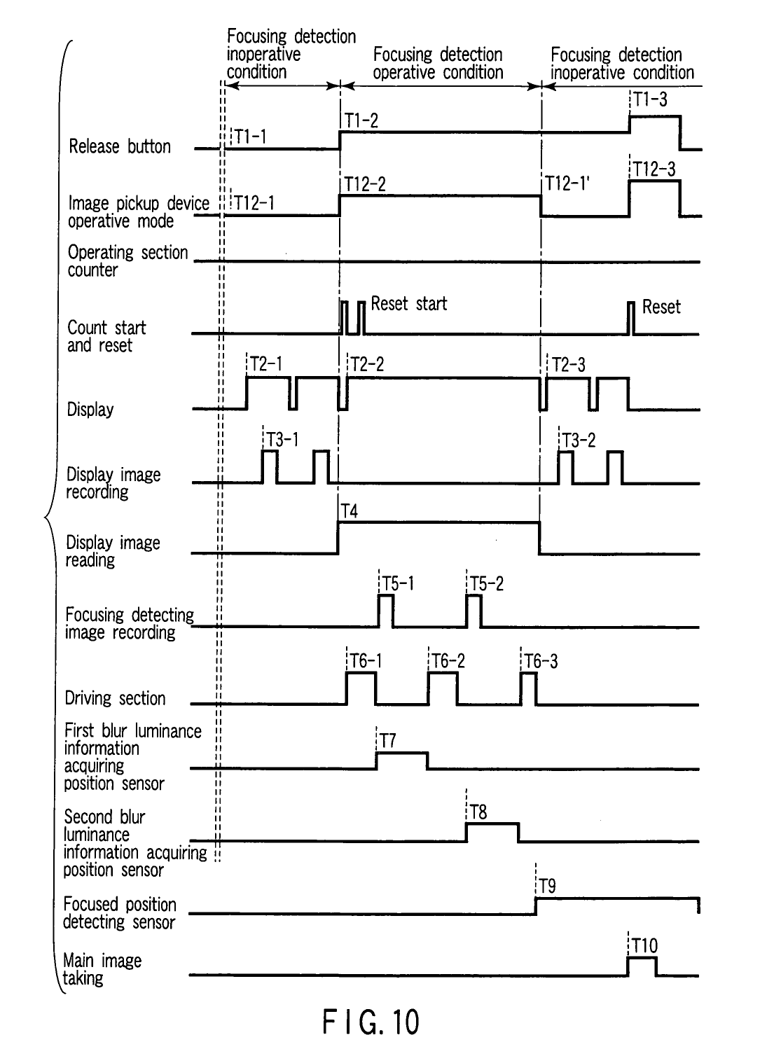

A second embodiment of the present invention will be described below. FIG. 5 is a diagram showing the configuration of an image pickup apparatus in accordance with the second embodiment of the present invention. In the second embodiment, the image pickup apparatus is characterized by comprising an image pickup device operation control section 15 that controls the operation of the image pickup device 2. FIG. 10 is a timing chart illustrating the effects of the second embodiment. In FIG. 10, T12-1 denotes a display sampling mode, T12-2 denotes a focusing detection sampling mode, and T12-3 denotes a main image taking sampling mode. After the release button 8 is half-depressed to end the operation of the driving section 6 at T6-1 and before luminance information is acquired at T5-1, the image pickup device operation control section 15 changes the sampling mode to the focusing detection sampling mode.

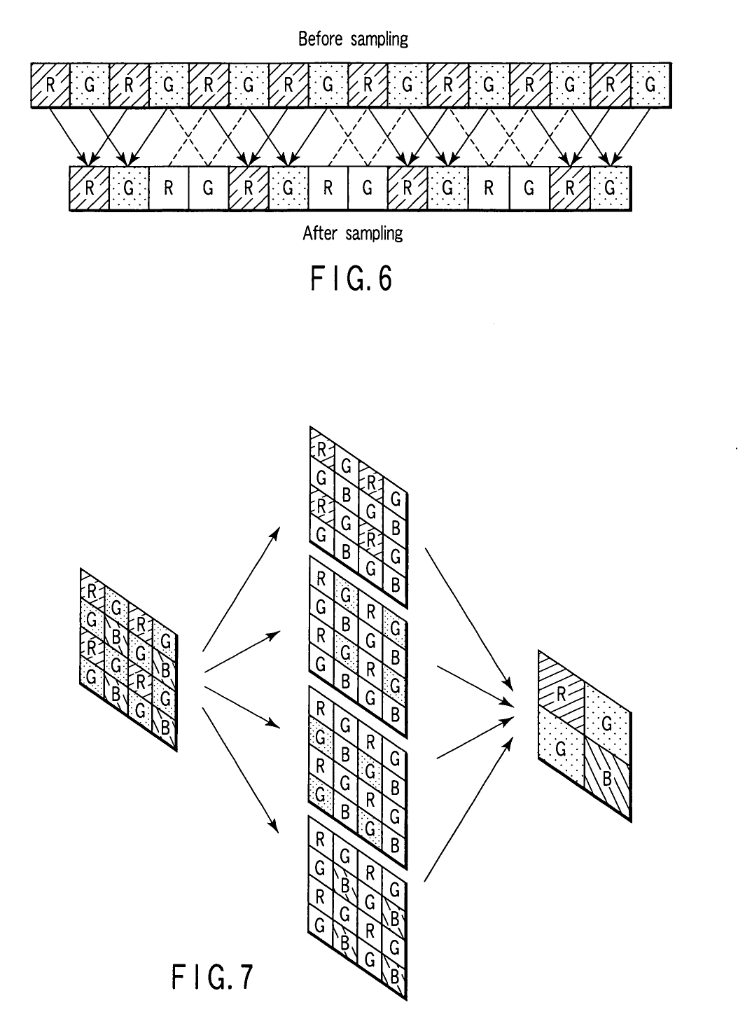

The timing at which the sampling mode is changed is not particularly limited provided that the change is made during the period from T1-2 to T6-1, when driving of the optical system 1 is ended. However, in the example of configuration in FIG. 5, to compensate for the timing, the image pickup device operation control section 15 receives an end signal from the driving section condition detecting section 7. At T5-1 and T5-2, luminance information is obtained in the focusing detection sampling mode. For sampling of the focusing detection condition, what is called pixel mixed reading is performed by, for example, additively mixing two horizontal images as shown in FIG. 6 or additively mixing two vertical pixels and two horizontal pixels as shown in FIG. 7. This enables sampling bands in the X and Y directions to be matched, allowing luminance information to be obtained at a high frame rate over a wide range. After the focusing operation is finished, the device changes to the display sampling mode or the main image taking sampling mode.

In this case, the image data for the pixel mixed reading operation is used only for the calculation for focusing detection. No image for display is generated. As is the case with the configuration shown in FIG. 1, image display data may be held in the display image recording section 11 before being displayed. Then, to acquire luminance information for focusing detection, the image information in the buffer may be presented.

### Variation of the Second Embodiment

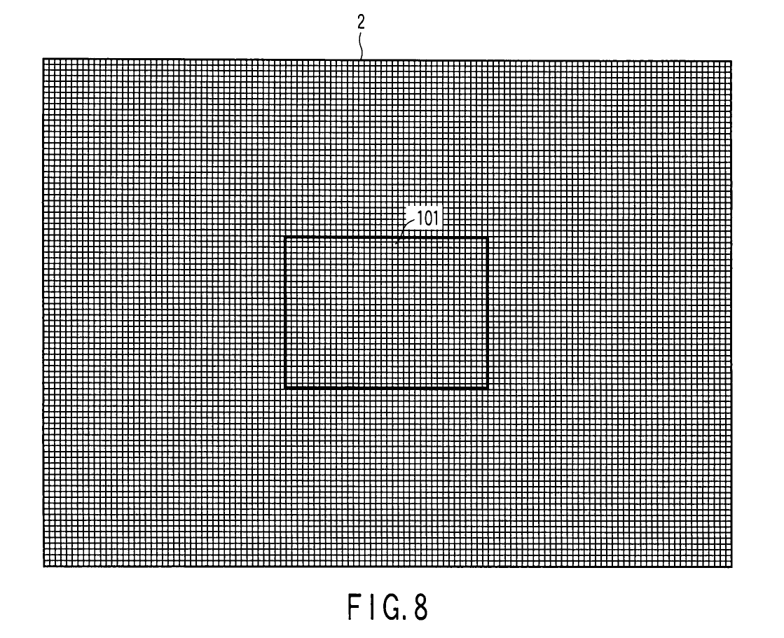

In the sampling mode suitable for acquiring luminance information for focusing detection in accordance with the second embodiment, if the area of an object for focusing is limited, a partial area on the image pickup device 2 is sampled. This operation is possible when the image pickup device 2 has a function of acquiring data on the basis of X and Y addresses, like a MOS imager. For example, as shown in FIG. 8, only an area 101 in the vicinity of the center of the image pickup device 2 is sampled to provide luminance information of a high definition at a high frame rate. In this case, since the luminance information acquired does not reflect the image information on the entire area on the image pickup device 2, no image for display is generated. To acquire luminance information for focusing detection, image information in a memory is presented.

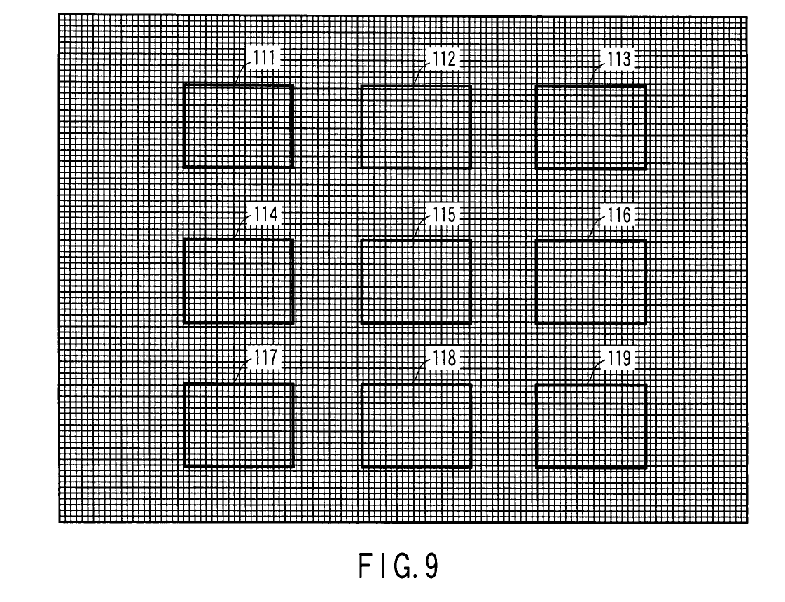

Alternatively, a plurality of partial areas may be set and nine areas 111 to 119 may be sampled as shown in FIG. 9. In this case, since the luminance information acquired does not reflect the image information over the entire area on the image pickup device, no image for display is generated as described above.

What is claimed is:

1. An image pickup apparatus having a focusing detection operative condition and a focusing detection inoperative condition, the apparatus comprising:
an optical system which forms an image based on light from object;
an image pickup device which obtains the image of the object;
a display section which displays the image of the object;
a focusing detecting section; and
an image pickup instructing section which permits the focusing detecting section to go into the focusing detection operative condition and which instructs an image of the object to be picked up,
wherein the display section displays the image of the object taken with the optical system in a predetermined arrangement when the image pickup instructing section permits the focusing detection operative condition.

2. The image pickup apparatus according to claim 1, wherein the image of the object taken with the optical system in the predetermined arrangement is taken with the arrangement of the optical system made before the focusing detection operative condition.

3. The image pickup apparatus according to claim 1, wherein the image of the object taken with the optical system in the predetermined arrangement is taken with a first predetermined arrangement of the optical system acquired in one focusing detection operative condition.

4. The image pickup apparatus according to claim 2, wherein the display device further displays the image taken with the arrangement of the optical system established for the one focusing detection operative condition.

5. The image pickup apparatus according to claim 3, wherein the display device further displays the image taken with the arrangement of the optical system established for the one focusing detection operative condition.

6. The image pickup apparatus according to claim 4, wherein the image pickup instructing section permits a plurality of focusing detection operative conditions, and
the display section displays the image taken with the arrangement of the optical system established for the one focusing detection operative condition, in a next focusing detection operative condition.

7. The image pickup apparatus according to claim 5, wherein the image pickup instructing section permits a plurality of focusing detection operative conditions, and
the display section displays the image taken with the arrangement of the optical system established for the one focusing detection operative condition, in a next focusing detection operative condition.

8. The image pickup apparatus according to claim 1, wherein the image pickup device has a function of performing a plurality of reading operations, and further has an image pickup device control section which controls the reading operation of the image pickup device, and
in the focusing detection operative condition, pieces of luminance information on a plurality of pixels in a vicinity of the pixels on the image pickup device are additively mixed together and then read.

9. The image pickup apparatus according to claim 1, wherein the image pickup device has a function of performing a plurality of reading operations, and further has an image pickup device control section which controls the reading operation of the image pickup device, and
in the focusing detection operative condition, luminance information on a partial area on the image pickup device which is made up of at least one pixel is read.

10. The image pickup apparatus according to claim 1, wherein a focusing information acquiring section which acquires the focusing information comprises:
an image acquiring section which uses the image pickup device to acquire a plurality of images with different blur levels formed by light having passed through the optical system;
a luminance information acquiring section which acquires luminance information on corresponding areas in at least two of the plurality of images;
a spread parameter calculating section which calculates a spread parameter from the luminance information on the corresponding areas; and
a control section which relates the spread parameter to a command value sent to a drive section which drives the optical system to a position at which an image focusing on the object is obtained.

11. The image pickup apparatus according to claim 1, further comprising:
a recording section in which image information to be displayed on the display section is recorded;
a counter which measures the time for which the image information recorded in the recording section is held; and
an updating section which updates the image information recorded in the recording section.
